(19) United States
(12) Patent Application Publication
(10) Pub. No.: US 2009/0009416 A1
(43) Pub. Date: Jan. 8, 2009

(54) FULL-MOTION MULTI-ANTENNA MULTI-FUNCTIONAL PEDESTAL

(75) Inventor: E. Mitchell Blalock, Atlanta, GA (US)

Correspondence Address: TOWNSEND AND TOWNSEND AND CREW LLP;VIASAT, INC (CLIENT #017018), TWO EMBARCADERO CENTER, EIGHTH FLOOR, CA, 94111, US

(73) Assignee: ViaSat, Inc., Carlsbad, CA (US)

(21) Appl. No.: 12/167,078

(22) Filed: Jul. 2, 2008

Related U.S. Application Data
(60) Provisional application No. 60/947,536, filed on Jul. 2, 2007.

(51) Int. Cl. H01Q 1/42; H01Q 21/00; H01Q 3/00

(52) U.S. Cl. 343/758; 343/872; 343/893

(57) ABSTRACT

According to the invention, a system for providing a plurality of antennas in a single radome is disclosed. The system may include a first antenna and a second antenna. The first antenna may have a first axis. The second antenna may have a second axis. The second antenna may be fixedly coupled with the first antenna such that the first axis may be substantially orthogonal to the second axis.

### CROSS-REFERENCE TO RELATED APPLICATIONS

This application claims priority to Provisional U.S. Patent Application No. 60/947,536 filed Jul. 2, 2007, entitled “FULL-MOTION MULTI-ANTENNA MULTI-FUNCTIONAL PEDESTAL,” the entire disclosure of which is hereby incorporated by reference, for all purposes, as if fully set forth herein.

### BACKGROUND OF THE INVENTION

This invention relates generally to antenna positioning and movement. More specifically the invention relates to multi-antenna on single pedestal systems and methods.

Occasionally, a single antenna may only provide a limited amount of functionality. Merely by way of example, a certain antenna may only be useful for communicating within a certain radio frequency range or band. If a system requires functionality in multiple bands, multiple antennas may be provided to satisfy such requirements.

However, in certain systems, for instance those using parabolic antennas, spatial and fiscal considerations make providing two completely separate antenna systems troublesome. Often, redundant systems will have to be provided for each system.

To avoid these drawbacks, sometimes multiple antennas are provided which both utilize a single set of related equipment. For example, two antennas may be provided on a single pedestal, with common electronics and processing equipment servicing both antennas. The pedestal moves both antennas when movement is necessary for the active antenna.

However, space and other considerations still remain. Unless the size of each antenna is decreased, thereby reducing performance, side-by-side and back-to-back antenna configurations both require a substantial additional amount of space, and/or cause limitations in freedom of movement of either one or both of the antennas.

### BRIEF DESCRIPTION OF THE INVENTION

In one embodiment, a system for providing a plurality of antennas in a single radome is provided. The system may include a first antenna and a second antenna. The first antenna may have a first axis. The second antenna may have a second axis. The second antenna may be fixedly coupled with the first antenna such that the first axis may be substantially orthogonal to the second axis.

In another embodiment, a method for selectively operating a particular antenna among a plurality of antennas on a single pedestal is provided. The method may include providing a first antenna having a first axis. The method may also include providing a second antenna having a second axis. The second antenna may be fixedly coupled with the first antenna such that the first axis is at a fixed angle to the second axis. The method may further include providing a pedestal. The first antenna and the second antenna may be movably coupled with the pedestal. The method may additionally include selecting either the first antenna or the second antenna. The method may furthermore include rotating both the first antenna and the second antenna based at least in part on a desired direction for an axis of the selected antenna.

In another embodiment, a system for providing a plurality of antennas in a single radome is provided. The system may include a first means, a second means, and a third means. The first means may be for communicating a first type of radio signals in a first direction. The second means may be for communicating a second type of radio signals in a second direction. The first means may be coupled with the second means such that the first direction is at a rigid angle to the second direction. The third means may be for collectively rotating the first means and the second means.

### BRIEF DESCRIPTION OF THE DRAWINGS

The present invention is described in conjunction with the appended figures:

FIG. 1 is an side view of an embodiment of the invention for providing multiple antennas on a single pedestal or a single radome.

In the appended figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION OF THE INVENTION

The ensuing description provides exemplary embodiments only, and is not intended to limit the scope, applicability or configuration of the disclosure. Rather, the ensuing description of the exemplary embodiments will provide those skilled in the art with an enabling description for implementing one or more exemplary embodiments. It being understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, systems, processes, and other elements in the invention may be shown as components in block diagram form in order not to obscure the embodiments in unnecessary detail. In other instances, well-known processes, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but could have additional steps not discussed or included in a figure. Furthermore, not all operations in any particularly described process may occur in all embodiments. A process may correspond to a method, a function, a procedure, etc. When a process corresponds to a function, its termination corresponds to a return of the function to the calling function or the main function.

Furthermore, embodiments of the invention may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

In one embodiment of the invention, a system for providing a plurality of antennas in a single radome is provided. The system may include a first antenna and a second antenna. The first antenna may have a first axis. The second antenna may have a second axis. The second antenna may be coupled with the first antenna such that the first axis may be at an angle to the second axis.

In some embodiments, one or more of the antennas may be parabolic antennas. In these embodiments, the axes of the antennas may be from the center of the parabolic dishes and extend substantially toward the direction of reception/transmission of the antenna.

In some embodiments, one or more of the antennas may be an X-Band antenna. In these or other embodiments, one or more of the antennas may be an S-Band antenna. In some embodiments, one or more of the antennas may be a combination X-Band and S-Band antenna. In come embodiments, one or more of the antennas may be a C-Band antenna.

In some embodiments, the antennas may be fixedly coupled together. In other embodiments, the antennas may be movably coupled together. The physical coupling between the antennas may be controlled and any angle between the axes of the antennas thereby controlled. In some embodiments, the axes of the antennas may be substantially coplanar when coupled.

In some embodiments, the angle at which the first axis is related to the second axis may be fixed or variable. In embodiments where the angle is fixed, the angle may be substantially orthogonal (ninety degrees), substantially obtuse, or substantially acute. In embodiments where the angle is variable, the angle may vary between orthogonal and obtuse, orthogonal and acute, and/or acute and obtuse.

In some embodiments, the system may also include a radome, wherein the first antenna and the second antenna are disposed within the primarily spherical radome. The radome may be configured to protect the antennas from the elements or other interferences. The radome may be constructed such that it presents minimal interference to radio signals entering and exiting the radome.

In some embodiments, the radome may be smaller than if the first antenna and the second antenna were coupled such that the first axis was substantially parallel to the second axis. These embodiments demonstrate how the systems of the invention will have smaller radomes and footprints than other systems with antennas coupled together in different configurations such as side-by-side or back-to-back configurations. In some embodiments, the radome may be the same minimum size capable of covering the system if only one antenna was present.

In some embodiments, the system may also include a pedestal. The pedestal may be of a height sufficient to allow the first axis to be rotated to parallel with a substantially level horizon. In these embodiments, the bottom of a parabolic antenna used in some embodiments may be at a sufficient level above the base of the pedestal when the axis of that antenna is aimed level with the horizon.

In embodiments with pedestals, the system may also include a movement system. The movement system may movable couples the first antenna and the second antenna with the pedestal. The movement system may be configured to rotate both the first antenna and the second antenna based at least in part on a selection of antennas, and a desired direction for an axis of the selected antenna. In some embodiments, the movement system may also actuate changing of a variable angle and/or position between the coupled antennas.

The selection of antennas and the desired direction of the axis may be selected and/or determined, manually and/or automatically, possibly with the use of a processor. The processor may also be running tracking software or algorithms to automatically control the movement system over time and/or in response to outside variables.

In another embodiment of the invention, a method for selectively operating a particular antenna among a plurality of antennas on a single pedestal is provided. The method may include providing a first antenna having a first axis. The method may also include providing a second antenna having a second axis. The second antenna may be fixedly coupled with the first antenna such that the first axis is at an angle to the second axis. As discussed above, the angle may be fixed or variable. In some embodiments, the method may include varying the angle.

The method may further include providing a pedestal. The first antenna and the second antenna may be movably coupled with the pedestal. The method may additionally include selecting either the first antenna or the second antenna. The method may furthermore include rotating both the first antenna and the second antenna based at least in part on a desired direction for an axis of the selected antenna.

In another embodiment of the invention, a system for providing a plurality of antennas in a single radome is provided. The system may include a first means, a second means, and a third means. The first means may be for communicating a first type of radio signals in a first direction. In some embodiments, merely by way of example, the first means may include an antenna or any other device or mechanism known now, or in the future, to communicate (i.e. transmit and/or receive) radio signals. The second means may be for communicating a second type of radio signals in a second direction. The first means may be coupled with the second means such that the first direction is at an angle to the second direction. In some embodiments, merely by way of example, the second means may include an antenna or any other device or mechanism known now, or in the future, to communicate (i.e. transmit and/or receive) radio signals. In varying embodiments, the angle between the two directions may be rigid or variable. In some embodiments, the system may further include an angular adjustment system configured to change the angle between the two directions.

The third means may be for collectively rotating the first means and the second means. In some embodiments, merely by way of example, the third means may include a movement system or any other device or mechanism known now, or in the future, to rotate the first means and the second means.

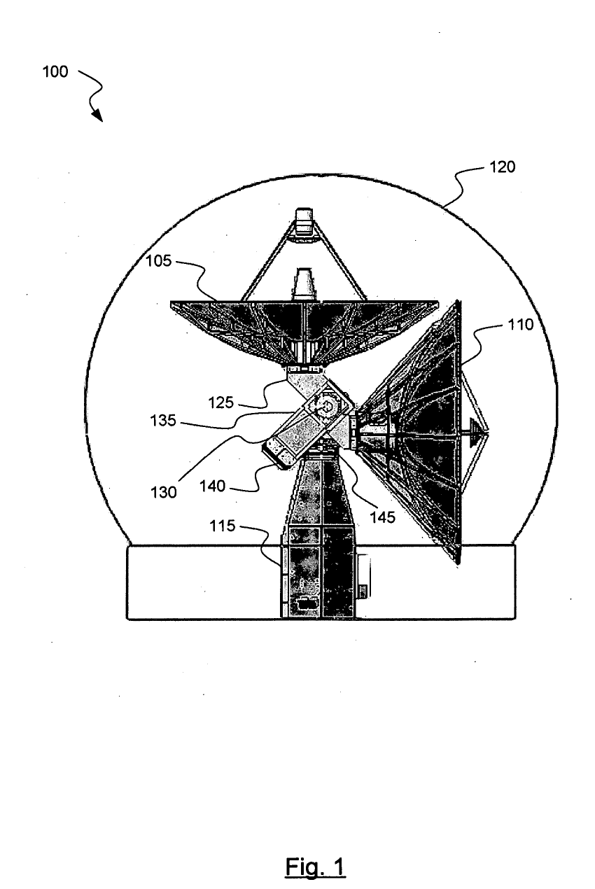

Turning now to FIG. 1, one system 100 of the invention is shown that houses two parabolic antennas 105, 110 on a single pedestal 115 in a single radome 120. In this embodiment, first antenna 105 is fixedly coupled with second antenna 110 via first member 125.

The axes of antennas 105, 110 are, in this example, mounted orthogonal to each other. In other embodiments, the angle between the axes of the antennas may be obtuse or acute. In this embodiment, the axes of antennas 105, 110 are also coplanar.

In some embodiments, such as the one shown, an elevation over azimuth system may be used to rotate antennas 105, 100. One example of such a system is a Series 3420 system available from ViaSat, Inc. at 6155 El Camino Real, Carlsbad, Calif. 92009.

In this embodiment, first member 125 may be rotatable around pivot point 130, enabling elevation adjustment of the active antenna 105, 110. Pivot point 130 may connect first member 125 to second member 135.

Second member 135 may include counterweighting 140 configured to balance the load on the movement system between antennas 105, 110. The counterweights may be positioned such that they may rotate past pedestal 115 when elevation adjustments are made by the system.

Second member 135 is coupled with third member 145. Third member 145 may be rotatably coupled with pedestal 115, enabling azimuth adjustment of the active antenna 105, 110.

By employing systems of the invention, including system 100 shown in FIG. 1, the size of the radome necessary to house a two-antenna system may be decreased if the size of the antennas remains constant. Taking for example the embodiment shown in FIG. 1, if antennas the same size as antennas 105, 110 were mounted side-by-side, the size of radome 120 would increase. Such a configuration might also increase the torque strain on any movement system necessary to adjust the position of the antennas, thereby requiring a more robust and costly movement system.

Alternatively, if antennas 105, 110 in FIG. 1 were mounted back-to-back, and their size remained constant, extension pieces in the movement system might be necessary to obtain usable range of motion of the system, increasing the size of radome. Even then, the at-horizon and below-horizon capabilities present in the embodiments of the current invention could be impeded.

A number of variations and modifications of the disclosed embodiments can also be used. For example, different movement systems could be used, possibly when high speed and/or torque are necessary, to rotate the antennas. Merely by way of example, some movement systems are discussed in commonly-owned and co-pending U.S. patent application Ser. Nos. 11/747,130; 11/747,134; 12/119,259; 12/119,273; and 12/119,284, the entire disclosures of all of which are hereby incorporated by reference, for all purposes, as if fully set forth herein.

Also, while some of the embodiments discussed are employed for adjusting directions of antennas, other embodiments could be employed to change the orientation of devices. For example, the systems and methods described above could be used to rotate weapons systems, for example mounted firearms, lasers and/or sonic systems. Other possible uses include sports equipment such as ball throwers. Optical systems could use the systems and methods described above to rotate lenses, mirrors and/or other optic components. Robotic arms could also be manipulated in a similar fashion, perhaps in manufacturing environments where one or more robotic arm must perform work in a variety of positions.

The invention has now been described in detail for the purposes of clarity and understanding. However, it will be appreciated that certain changes and modifications may be practiced within the scope of the appended claims.

What is claimed is:

1. A system for providing a plurality of antennas in a single radome, wherein the system comprises:
a first antenna, wherein the first antenna has a first axis;
a second antenna, wherein:
the second antenna has a second axis; and
the second antenna is fixedly coupled with the first antenna such that the first axis is substantially orthogonal to the second axis.

2. The system for providing a plurality of antennas in a single radome of claim 1, wherein the first axis and the second axis are substantially coplanar.

3. The system for providing a plurality of antennas in a single radome of claim 1, wherein the system further comprises a primarily spherical radome, wherein the first antenna and the second antenna are disposed within the primarily spherical radome.

4. The system for providing a plurality of antennas in a single radome of claim 3, wherein the radome is smaller than if the first antenna and the second antenna were coupled such that the first axis was substantially parallel to the second axis.

5. The system for providing a plurality of antennas in a single radome of claim 1, wherein the system further comprises a pedestal, and wherein the pedestal is of a height sufficient to allow the first axis to be rotated to parallel with a substantially level horizon.

6. The system for providing a plurality of antennas in a single radome of claim 1, wherein the system further comprises:
a pedestal; and
a movement system, wherein:
the movement system movable couples the first antenna and the second antenna with the pedestal; and
the movement system is configured to rotate both the first antenna or the second antenna based at least in part on a selection of antennas, and a desired direction for an axis of the selected antenna.

7. The system for providing a plurality of antennas in a single radome of claim 1, wherein the first antenna comprises an X-Band antenna.

8. The system for providing a plurality of antennas in a single radome of claim 7, wherein the first antenna further comprises an S-Band antenna.

9. The system for providing a plurality of antennas in a single radome of claim 1, wherein the second antenna comprises a C-Band antenna.

10. A method for selectively operating a particular antenna among a plurality of antennas on a single pedestal, wherein the method comprises:
providing a first antenna having a first axis;
providing a second antenna having a second axis, wherein the second antenna is fixedly coupled with the first antenna such that the first axis is at a fixed angle to the second axis;
providing a pedestal, wherein the first antenna and the second antenna are movably coupled with the pedestal;
selecting either the first antenna or the second antenna;
rotating both the first antenna and the second antenna based at least in part on a desired direction for an axis of the selected antenna.

11. The method for selectively operating a particular antenna among a plurality of antennas on a single pedestal of claim 10, wherein the fixed angle is substantially ninety degrees.

12. A system for providing a plurality of antennas in a single radome, wherein the system comprises:
a first means for communicating a first type of radio signals in a first direction;
a second means for communicating a second type of radio signals in a second direction, wherein the first means is coupled with the second means such that the first direction is at a rigid angle to the second direction; and
a third means for collectively rotating the first means and the second means.

13. The system for providing a plurality of antennas in a single radome of claim 12, wherein the first means comprises an antenna.

14. The system for providing a plurality of antennas in a single radome of claim 12, wherein the second means comprises an antenna.

15. The system for providing a plurality of antennas in a single radome of claim 12, wherein the third means comprises a movement system.

16. The system for providing a plurality of antennas in a single radome of claim 12, wherein the system further comprises an angular adjustment system configured to change the rigid angle.
